(19) United States
(12) Patent Application Publication
(10) Pub. No.: US 2014/0172260 A1
(43) Pub. Date: Jun. 19, 2014

(54) Method for Setting the Braking Torque of a Hydrodynamic Retarder

(71) Applicant: Roland Scherer, Crailsheim (DE)

(72) Inventor: Roland Scherer, Crailsheim (DE)

(73) Assignee: Voith Patent GmbH, Hiidenheim (DE)

(21) Appl. No.: 14/113,572

(22) PCT Filed: Mar. 13, 2013
(86) PCT No.: PCT/EP2013/055101

§ 371 Date: Oct. 23, 2013

(30) Foreign Application Priority Data
Mar. 14, 2012 (DE) 10 2012 004 985.4

(51) Int. Cl. B60T 10/02; B60T 1/087

(52) U.S. Cl. CPC B60T 10/02; B60T 1/087
USPC 701/70

(57) ABSTRACT

The invention relates to a method for setting the braking torque of a hydrodynamic retarder in a vehicle, especially a truck, with the following steps:
activation of the hydrodynamic retarder and generation of a predetermined braking torque upon detecting an activation command for the hydrodynamic retarder, wherein the duration until the predetermined braking torque is provided by the retarder and/or the level of the braking torque of the retarder is variably adjustable over the time progression until reaching the predetermined braking torque.

The invention is characterized in that
the longitudinal acceleration of the vehicle will be detected or calculated, and the duration until the predetermined braking torque is provided by the retarder and/or the level of the braking torque of the retarder over the time progression until reaching the predetermined braking torque is set depending on the longitudinal acceleration of the vehicle.

The present invention relates to a method for setting the braking torque of a hydrodynamic retarder in a vehicle, especially a truck, specifically according to the preamble of claim 1, and a method for setting or holding a constant speed of such a vehicle, specifically according to the preamble of claim 9. The invention can also be applied to other vehicles, e.g. rail vehicles.

It is known from the patent specification DE 198 48 546 C1 to fill the working space of a hydrodynamic retarder from a storage space, wherein the speed of filling is set depending on a control pressure. A specific control pressure progression is generated for the control pressure after detecting a retarder activation command, which contains a so-called overshoot. This means that for a short period of time a higher pressure will be produced as a control pressure than the nominal pressure associated with the desired braking torque of the retarder to be set. In accordance with DE 198 48 546 C1, the overshoot is set in the control pressure progression depending on the storage air pressure from which the control pressure is produced, the retarder oil temperature, the retarder speed or the vehicle speed, the ABS signal, the axial load, the brake-pause interval or the level of the braking agent, the transverse acceleration of the vehicle, the outside temperature, the speed of the actuating element with which the retarder is activated, or the acceleration of the setpoint assignment. WO 00/24621 A1 and U.S. Pat. No. 6,601,925 B1 comprise a translation of the teachings outlined in DE 198 48 546 C1, without adding anything to its content despite terms that deviate therefrom.

The aforementioned specification shows measures which can considerably reduce the activation period of a hydrodynamic retarder without giving rise to the likelihood of triggering the anti-lock braking system of the vehicle or other undesirable “side-effects”.

It is a disadvantage in the state of the art in situations in which the vehicle will travel at first in a non-braked manner downhill and will therefore accelerate that upon activation of the hydrodynamic retarder and overshoot will occur more or less strongly in the vehicle speed depending on the downhill gradient and possibly further boundary conditions in order to set or prevent exceeding a predetermined, especially constant, speed. It is especially problematic when an actual speed of the vehicle is obtained which is several kilometers per hour over the setpoint speed in the overshoot, with the consequence that the hydrodynamic retarder will optionally be set to its maximum braking torque in order to reduce the overshooting speed again. This can lead to a situation that during stronger braking over a prolonged period of time, especially with the maximum braking torque, overheating of the coolant will occur, which depending on the security system will lead to an automatic reversal in the retarder braking torque. As a result, various speed progressions which are inconvenient to the driver will be obtained during braking of the vehicle.

The present invention is based on the object of providing a method for setting the braking torque of a hydrodynamic retarder in a vehicle which avoids the mentioned disadvantages in the state of the art. Furthermore, a method is provided for setting and holding a constant speed of a vehicle during downhill travel by setting the braking torque of a hydrodynamic retarder.

The object in accordance with the invention is achieved by a method with the features of claim 1. The dependent claims provide advantageous and especially appropriate embodiments of the invention. Claim 9 provides a method in accordance with the invention for setting or holding a constant speed of the vehicle.

In accordance with the invention, an activation of the hydrodynamic retarder and a generation of a predetermined breaking torque with said retarder is produced when an activation command is detected for the hydrodynamic retarder, wherein the activation command is generated for example by a speed control system or adaptive cruise control system of the vehicle, wherein the duration is adjustable until the predetermined braking torque is provided by the retarder and/or the level of the braking torque of the retarder can be changed over the temporal progression until reaching the predetermined braking torque, i.e. that such time is variably adjustable.

In accordance with the invention, the longitudinal acceleration of the vehicle is further detected or calculated as well as the duration until the predetermined braking torque is provided by the retarder and/or the level of the braking torque of the retarder is set over the temporal progression until reaching the predetermined braking torque depending on the longitudinal acceleration of the vehicle.

As a result of setting the braking torque of the hydrodynamic retarder in accordance with the invention, the vehicle can be driven during downhill travel at a constant speed, i.e. such a speed can either be set or held, wherein the vehicle will travel downhill in a non-braked manner especially prior to the activation of the hydrodynamic retarder.

The predetermined braking torque can especially be a constant braking torque for example, which is associated with one of several gear-shifting steps, which can manually be set by the driver by an input apparatus. The predetermined braking torque can also especially be a constant braking torque which is associated with one of several gear-shifting steps, which are adjustable by a vehicle assistance system such as a cruise control or adaptive cruise control of the vehicle. However, non-constant braking torques or predetermined braking torque progressions can also be considered as a predetermined braking torque.

The longitudinal acceleration of the vehicle can be detected continuously for example or in predetermined intervals. Alternatively, it will only be detected during or after detection of an activation command for the hydrodynamic retarder. A calculation from the vehicle speed can also be considered instead of detection for example. The rising gradient of the actual speed can be calculated for example from the detected or calculated vehicle speed.

According to an advantageous embodiment of the method in accordance with the invention, the duration until the predetermined braking torque is provided by the retarder will be reduced in the case of a comparatively larger longitudinal acceleration of the vehicle which was detected or calculated, or a comparatively larger braking torque will be set over the temporal progression until reaching the predetermined braking torque than in the case of a comparatively lower longitudinal acceleration of the vehicle.

In addition to the longitudinal acceleration of the vehicle, the speed of the vehicle can be detected or calculated and an activation command for the hydrodynamic retarder can be generated upon reaching or exceeding a predetermined setpoint speed or upon reaching a speed of the vehicle which is lower than the setpoint speed and lies a predetermined distance beneath the setpoint speed in order to substantially prevent overshooting.

In accordance with an embodiment in accordance with the invention, the braking torque of the retarder can be set by applying a control pressure to a working medium store or working medium circuit. A working medium space of the retarder which is formed between two blade wheels of the retarder is filled with working medium from the working medium store and/or from the working medium circuit for hydrodynamic power transmission. The control pressure progression over time will be set after the detection of the activation command depending on the longitudinal acceleration of the vehicle,

Alternatively, the braking torque of the retarder will be set by applying the control pressure to a throttle valve, which is provided in the direction of flow of the working medium behind the working space of the retarder. In this embodiment too, the control pressure progression over time can be set after the detection of the activation command depending on the longitudinal acceleration of the vehicle.

It is especially advantageous if a larger overshoot is set with increasing longitudinal acceleration of the vehicle after the detection of the activation command at the beginning of the braking process in the control pressure progression. As a result, smooth commencement of the retarder braking effect is achieved in combination with low longitudinal acceleration of the vehicle and strong activation of the retarder under high longitudinal acceleration of the vehicle.

The retarder or the associated working medium circuit can be operated with oil, water or a water mixture. Other working media can also principally be considered. The control pressure will usually be provided by a compressed air system with air as the control medium. Other embodiments can also be considered in this case.

The invention will be described below by reference to an embodiment shown by way of example in the drawings, wherein:

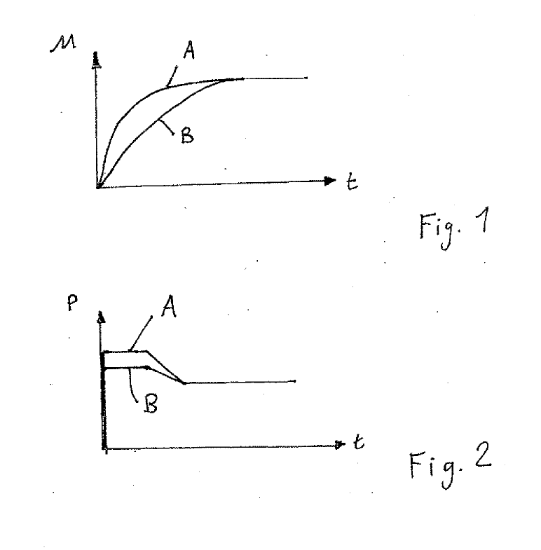

FIG. 1 shows two different braking torque curves of a hydrodynamic retarder during the activation of the same, which can be set depending on the detected or calculated longitudinal acceleration of the vehicle;

FIG. 2 shows examples for possible control pressure curves in order to achieve the braking torque curves according to FIG. 1.

FIG. 1 shows two different possible adjustable braking torque curves of a hydrodynamic retarder over time, starting at a point in time zero, in which an activation command for the hydrodynamic retarder is detected. In accordance with the curve A, a comparatively higher braking torque than in curve B is set in the time progression until reaching the predetermined braking torque. Furthermore, the predetermined braking torque is reached more rapidly, Alternatively, the braking torque curves (in this case according to the curves A and B) only differ with respect to height, and the predetermined braking torque, which is represented in this case as a constant braking torque, will be reached after the expiration of the same time interval after detecting the activation command.

FIG. 2 shows a potential control pressure curve by way of example in order to achieve the braking torque curve A according to FIG. 1 and the braking torque curve B. In order to achieve the braking torque curve A of FIG. 1, the overshoot in the control pressure curve over time is larger than in the case of the braking torque curve B. It could also be provided that an overshoot is set in the control pressure curve only for the braking torque curve A, but not in case B.

The progression of curve A can be set for example in a detected or calculated higher longitudinal acceleration of the vehicle than the progression of curve B.

1-10. (canceled)

11. A method for setting the braking torque of a hydrodynamic retarder in a vehicle, the method comprising:
activation of the hydrodynamic retarder and generation of a predetermined braking torque upon detecting an activation command for the hydrodynamic retarder, wherein the duration until the predetermined braking torque is provided by the retarder and/or the level of the braking torque of the retarder is variably adjustable over the time progression until reaching the predetermined braking torque;
wherein the longitudinal acceleration of the vehicle will be detected or calculated, and the duration until the predetermined braking torque is provided by the retarder and/or the level of the braking torque of the retarder over the time progression until reaching the predetermined braking torque is set depending on the longitudinal acceleration of the vehicle.

12. The method according to claim 11, wherein in the case of a comparatively higher longitudinal acceleration of the vehicle the duration will be reduced and/or a comparatively higher braking torque over the temporal progression will be set than in the case of a comparatively lower longitudinal acceleration of the vehicle.

13. The method according to claim 11, wherein the longitudinal acceleration of the vehicle will be detected or calculated continuously.

14. The method according to claim 12, wherein the longitudinal acceleration of the vehicle will be detected or calculated continuously.

15. The method according to claim 11, wherein the speed of the vehicle will be detected or calculated additionally, and an activation command for the hydrodynamic retarder will be generated upon reaching or above a predetermined setpoint speed, or upon reaching a speed of the vehicle at a predetermined distance beneath the setpoint speed.

16. The method according to claim 12, wherein the speed of the vehicle will be detected or calculated additionally, and an activation command for the hydrodynamic retarder will be generated upon reaching or above a predetermined setpoint speed, or upon reaching a speed of the vehicle at a predetermined distance beneath the setpoint speed.

17. The method according to claim 13, wherein the speed of the vehicle will be detected or calculated additionally, and an activation command for the hydrodynamic retarder will be generated upon reaching or above a predetermined setpoint speed, or upon reaching a speed of the vehicle at a predetermined distance beneath the setpoint speed.

18. The method according to claim 14, wherein the speed of the vehicle will be detected or calculated additionally, and an activation command for the hydrodynamic retarder will be generated upon reaching or above a predetermined setpoint speed, or upon reaching a speed of the vehicle at a predetermined distance beneath the setpoint speed.

19. The method according to claim 11, wherein the braking torque of the retarder is set by applying a control pressure to a working medium store or a working medium circuit, from which a working space of the retarder formed between two blade wheels of the retarder is filled with working medium for hydrodynamic power transmission, and the control pressure progression over time is set after the detection of the activation command depending on the longitudinal acceleration.

20. The method according to claim 12, wherein the braking torque of the retarder is set by applying a control pressure to a working medium store or a working medium circuit, from which a working space of the retarder formed between two blade wheels of the retarder is filled with working medium for hydrodynamic power transmission, and the control pressure progression over time is set after the detection of the activation command depending on the longitudinal acceleration.

21. The method according to claim 13, wherein the braking torque of the retarder is set by applying a control pressure to a working medium store or a working medium circuit, from which a working space of the retarder formed between two blade wheels of the retarder is filled with working medium for hydrodynamic power transmission, and the control pressure progression over time is set after the detection of the activation command depending on the longitudinal acceleration.

22. The method according to claim 14, wherein the braking torque of the retarder is set by applying a control pressure to a working medium store or a working medium circuit, from which a working space of the retarder formed between two blade wheels of the retarder is filled with working medium for hydrodynamic power transmission, and the control pressure progression over time is set after the detection of the activation command depending on the longitudinal acceleration.

23. The method according to claim 11, wherein the braking torque of the retarder is set by applying a control pressure to a working space of the retarder, which is or can be filled with a working medium and which is formed between two blade wheels of the retarder, in a working medium circuit in a throttle valve arranged downstream in the direction of flow of the working medium, and the control pressure progression over time is set after detecting the activation command depending on the longitudinal acceleration.

24. The method according to claim 12, wherein the braking torque of the retarder is set by applying a control pressure to a working space of the retarder, which is or can be filled with a working medium and which is formed between two blade wheels of the retarder, in a working medium circuit in a throttle valve arranged downstream in the direction of flow of the working medium, and the control pressure progression over time is set after detecting the activation command depending on the longitudinal acceleration.

25. The method according to claim 13, wherein the braking torque of the retarder is set by applying a control pressure to a working space of the retarder, which is or can be filled with a working medium and which is formed between two blade wheels of the retarder, in a working medium circuit in a throttle valve arranged downstream in the direction of flow of the working medium, and the control pressure progression over time is set after detecting the activation command depending on the longitudinal acceleration.

26. The method according to claim 19, wherein with rising longitudinal acceleration of the vehicle an increasingly rising overshoot will be set in the control pressure progression after detecting the activation command at the beginning of the braking process.

27. The method according to claim 23, wherein with rising longitudinal acceleration of the vehicle an increasingly rising overshoot will be set in the control pressure progression after detecting the activation command at the beginning of the braking process.

28. The method according to claim 11, wherein the retarder is operated with a working medium of oil, water or a water mixture.

29. A method for setting or holding a constant speed of a vehicle, especially a truck, during downhill travel, characterized in that the vehicle is braked by activating a hydrodynamic retarder and setting a braking torque, wherein the braking torque is set according to claim 11.

30. The method according to claim 29, wherein the vehicle is driven in a non-braked manner prior to activating the hydrodynamic retarder.
